(19) United States
(12) Patent Application Publication
(10) Pub. No.: US 2019/0039512 A1
(43) Pub. Date: Feb. 7, 2019

(54) VEHICLE DISPLAY DEVICE

(71) Applicant: TOYOTA JIDOSHA KABUSHIKI KAISHA, Toyota-shi (JP)

(72) Inventors: Hiroaki TAKI, Okazaki-shi (JP); Junichi KATO, Toyota-shi (JP)

(73) Assignee: TOYOTA JIDOSHA KABUSHIKI KAISHA, Toyota-shi (JP)

(21) Appl. No.: 16/050,620

(22) Filed: Jul. 31, 2018

(30) Foreign Application Priority Data
Aug. 2, 2017 (JP) 2017-150223

(51) Int. Cl. B60Q 1/50; B60K 35/00

(52) U.S. Cl. CPC B60Q 1/503; B60K 2350/1092; B60K 35/00

(57) ABSTRACT

A vehicle display device includes a consumption efficiency information processing portion configured to display information on consumption efficiency of an energy source during driving of a vehicle on a display unit, in which the vehicle includes a consumption efficiency improvement portion configured to include a plurality of types of efficiency improvement functions contributing to an improvement in the consumption efficiency. The consumption efficiency information processing portion includes an actual improvement effect calculating portion individually configured to calculate an actual improvement effect on the consumption efficiency resulting from each of the plurality of types of efficiency improvement functions, and an improvement effect display control portion configured to display the actual improvement effect obtained for each of the plurality of types of efficiency improvement functions on the display in a manner where each of the actual improvement effects are mutually compared.

This application claims priority from Japanese Patent Application No. 2017-150223 filed on Aug. 2, 2017, the disclosure of which is herein incorporated by reference in its entirety.

### TECHNICAL FIELD

The present invention relates to a vehicle display device and, more particularly, to a vehicle display device displaying information on consumption efficiency of an energy source during driving of a vehicle.

### BACKGROUND ART

A vehicular display device is proposed that has a consumption efficiency information processing portion displaying information on consumption efficiency of an energy source during driving of a vehicle, for example, fuel consumption of an engine-driven vehicle and specific power consumption (electric consumption) of an electric vehicle, on a display unit. A device described in Patent Document 1 is an example thereof and calculates the consumption efficiency from a running distance and a consumption amount of the energy source to obtain and display a proportion of the consumption efficiency exceeding a predetermined threshold as a consumption efficiency improvement effect.

### PRIOR ART DOCUMENT

### Patent Document

Patent Document 1: Japanese Laid-Open Patent Publication No. 2010-38754

### SUMMARY OF THE INVENTION

### Technical Problem

However, even though a consumption efficiency improvement effect is merely displayed, it is not known what kind of driving mode contributes to the improvement in consumption efficiency, and therefore, this is not necessarily sufficient for enhancing driver's awareness of improvement in consumption efficiency. Specifically, some of vehicles currently widely used have various efficiency improvement functions contributing to improvement in consumption efficiency such as a free-run running control in which an engine serving as a drive power source is separated from a power transmission path and stopped rotating during coasting with an accelerator turned off an idling reduction control in which an engine serving as a drive power source is stopped rotating during stop of a vehicle, or eco-driving in which an operation of an air conditioner is limited when an eco-driving mode is selected; however, since it is not known which function contributes to what extent to the improvement in consumption efficiency, the improvement effects on consumption efficiency resulting from the efficiency improvement functions cannot actually be felt.

The present invention was conceived in view of the situations and it is therefore an object of the present invention to enable a driver to recognize which function contributes to what extent to improvement in consumption efficiency when a plurality of efficiency improvement functions is included in terms of consumption efficiency of an energy source.

### Solution to Problem

To achieve the above object, a first aspect of the present invention provides a vehicle display device including a consumption efficiency information processing portion displaying information on consumption efficiency of an energy source during driving of a vehicle on a display unit, wherein (a) the vehicle includes a consumption efficiency improvement portion including a plurality of types of efficiency improvement functions contributing to an improvement in the consumption efficiency, wherein (b) the consumption efficiency information processing portion includes (b-1) an actual improvement effect calculating portion individually calculating an actual improvement effect (an estimated value of an actual improvement effect) on the consumption efficiency resulting from each of the plurality of types of efficiency improvement functions, and (b-2) an improvement effect display control portion displaying the actual improvement effect obtained for each of the plurality of types of efficiency improvement functions on the display in a manner where each of the actual improvement effects are mutually compared.

A second aspect of the present invention provides the vehicle display device recited in the first aspect of the invention wherein (a) the consumption efficiency information processing portion has a maximum improvement effect calculating portion calculating a maximum improvement effect in the case of an ideal driving which fulfills each of the plurality of types of efficiency improvement functions to the maximum in terms of improvement in the consumption efficiency respectively, and wherein (b) the improvement effect display control portion displays the actual improvement effect on the display device in a manner where each of the actual improvement effects is compared with the corresponding maximum improvement effect.

A third aspect of the present invention provides the vehicle display device recited in the second aspect of the invention wherein when it is determined that a proportion of the actual improvement effect to the corresponding maximum improvement effect is high or low according to a predefined determination criterion for each of the efficiency improvement functions, the improvement effect display control portion performs highlighting such that the type of the efficiency improvement function related to the determined actual improvement effect is identified.

A fourth aspect of the present invention provides the vehicle display device recited in any one of the first to third aspects of the invention wherein the improvement effect display control portion displays on the display device the actual improvement effect obtained for each of the plurality of types of efficiency improvement functions such that the actual improvement effects are evaluated using lengths in a bar chart.

A fifth aspect of the present invention provides the vehicle display device recited in any one of the first to fourth aspects of the invention wherein the actual improvement effect is at least one of a saving amount of the energy source being saved due to the efficiency improvement functions, a saving consumption efficiency that is a difference between a virtual consumption efficiency obtained by dividing a running distance by an amount obtained by adding the saving amount to a consumption amount of the energy source and an actual consumption efficiency, a travelable distance calculated by multiplying the saving amount by the actual consumption efficiency, and a money amount corresponding to the saving amount.

A sixth aspect of the present invention provides the vehicle display device recited in the fifth aspect of the invention wherein the improvement effect display control portion displays a numerical value of the actual improvement effect on the display unit.

A seventh aspect of the present invention provides the vehicle display device recited in any one of the first to sixth aspects of the invention wherein (a) the consumption efficiency improvement portion includes as one of the efficiency improvement functions a free-run running control portion separating an engine serving as a drive power source from a power transmission path to stop rotation during coasting with an accelerator turned off, and wherein (b) the actual improvement effect calculating portion calculates an energy source saving amount based on a rotation stop time of the engine due to the free-run running control portion and a fuel consumption amount during idling of the engine.

An eighth aspect of the present invention provides the vehicle display device recited in any one of the first to seventh aspects of the invention wherein (a) the consumption efficiency improvement portion includes as one of the efficiency improvement functions an idling reduction control portion stopping the rotation of the engine serving as the drive power source during stop of the vehicle, and wherein (b) the actual improvement effect calculating portion calculates an energy source saving amount based on a rotation stop time of the engine due to the idling reduction control portion and a fuel consumption amount during idling of the engine.

A ninth aspect of the present invention provides the vehicle display device recited in any one of the first to eighth aspects of the invention wherein (a) the consumption efficiency improvement portion includes as one of the efficiency improvement functions an eco-driving portion limiting an operation of an air conditioner when an eco-driving mode is selected, and wherein (b) the actual improvement effect calculating portion calculates a difference in consumption amount of the energy source due to a difference between an operation state of the air conditioner with operation limited by the eco-driving portion and an operation state of the air conditioner without operation limitation as a successive energy source saving amount so that the successive energy source saving amount is sequentially accumulated to calculate an energy source saving amount.

A tenth aspect of the present invention provides the vehicle display device recited in any one of the first to ninth aspects of the invention wherein (a) the vehicle includes a navigation device having road information from a departure place to a destination, wherein (b) the consumption efficiency information processing portion includes a predicted improvement effect calculating portion calculating a predicted improvement effect for each of the plurality types of efficiency improvement functions in the case of the ideal driving which fulfills the efficiency improvement function to the maximum in terms of improvement in the consumption efficiency based on the road information from the departure place to the destination, and wherein (c) the improvement effect display control portion displays the predicted improvement effect on the display unit.

An eleventh aspect of the present invention provides the vehicle display device recited in any one of the first to tenth aspects of the invention wherein the actual improvement effect calculating portion resets the actual improvement effect in accordance with any predetermined reset condition out of a driver's operation of a driving switch for enabling driving of the vehicle, a driver's reset operation of an odometer, filling of the energy source, a predefined running distance, a predefined driving time, a predefined consumption amount of the energy source, a stop of the vehicle, and a driver's reset operation to the actual improvement effect and newly calculates the actual improvement effect based on a driving operation after the reset.

A twelfth aspect of the present invention provides the vehicle display device recited in the eleventh aspect of the invention wherein the improvement effect display control portion stores the actual improvement effect of one or more times immediately before the reset and displays the actual improvement effect in a manner where the stored actual improvement effect is compared with a current actual improvement effect.

A thirteenth aspect of the present invention provides the vehicle display device recited in any one of the first to twelfth aspect of the invention wherein the energy source is at least one of a fuel of an engine, a fuel of a fuel cell, an electric energy stored in an in-vehicle battery.

### Advantageous Effects of the Invention

The vehicle display device as described above individually calculates the actual improvement effects on consumption efficiency resulting from the plurality of types of the efficiency improvement functions, and displays the effects on the display unit such that a comparison can mutually be made between the efficiency improvement functions, and therefore, the driver can recognize which function contributes to what extent to improvement in consumption efficiency among the multiple types of the efficiency improvement functions. As a result, the driver can actually feel the improvement effects on consumption efficiency resulting from the efficiency improvement functions and is also motivated to reflect the contribution of the efficiency improvement functions to the consumption efficiency on the driving operation for further improvement in the consumption efficiency by, for example, driving the vehicle such that the efficiency improvement function with low improvement effect is consciously fulfilled.

In the second aspect of the present invention, the vehicle display device calculates the maximum improvement effects in the case of the ideal driving which achieves the maximum performance for each of the plurality of types of the efficiency improvement functions, and displays the actual improvement effects on the display unit such that a comparison of the actual improvement effects can be made with the maximum improvement effects. Therefore, a margin of the improvement effect (a difference from the maximum improvement effect) on consumption efficiency resulting from each of the efficiency improvement functions can specifically be understood. As a result, the margin of each of the efficiency improvement functions can be reflected on the driving operation for aiming further improvement in the consumption efficiency by, for example, driving the vehicle such that the efficiency improvement function having a high margin is consciously fulfilled. Particularly, in the third aspect of the invention, the efficiency improvement function having a low or high proportion of the actual improvement effect to the maximum improvement effect is highlighted such that the type of the efficiency improvement function related to the actual improvement effect becomes identifiable. Therefore, the efficiency improvement function can easily be recognized and reflected on the driving operation.

In the fourth aspect of the invention, the actual improvement effect obtained for each of the plurality of types of the efficiency improvement functions is displayed on the display unit such that a comparison can be made therebetween based on the lengths in the bar chart. Therefore, a difference in relative contribution degree of each of the plurality of types of the efficiency improvement functions can easily be recognized.

In the sixth aspect of the invention, at least one of an energy source saving amount, a saving consumption efficiency, a travelable distance, and a saved money amount is calculated as an actual improvement effect, the specific numerical values are displayed. Therefore, the driver can easily specifically image the improvement effects on consumption efficiency resulting from each of the efficiency improvement functions.

In the seventh aspect of the invention, the consumption efficiency improvement portion includes the free-nm running control portion and the energy source saving amount is calculated based on the rotation stop time of the engine attributable to the free-run running control portion and the fuel consumption amount during idling of the engine. Therefore, the energy source saving amount, for example, can highly accurately be obtained as the actual improvement effect on consumption efficiency resulting from the free-run running. The saving consumption efficiency, the travelable distance, or the saved money amount can also be calculated as the actual improvement effect on consumption efficiency based on the energy source saving amount.

In the eighth aspect of the invention, the consumption efficiency improvement portion includes the idling reduction control portion and the energy source saving amount is calculated based on the rotation stop time of the engine attributable to the idling reduction control portion and the fuel consumption amount during idling. Therefore, the energy source saving amount, for example, can highly accurately be obtained as the actual improvement effect on consumption efficiency resulting from the idling reduction. The saving consumption efficiency, the travelable distance, or the saved money amount can also highly accurately be calculated as the actual improvement effect on consumption efficiency based on the energy source saving amount.

In the ninth aspect of the invention, the consumption efficiency improvement portion includes the eco-driving portion, and a difference in the consumption amount of the energy source due to a difference between the operation state of the air conditioner with operation limited by the eco-driving portion and the operation state of the air conditioner without operation limitation is calculated as the successive energy source saving amount so that the successive energy source saving amount is sequentially accumulated to calculate the cumulative energy source saving amount. Therefore, the energy source saving amount, for example, can highly accurately be obtained as the actual improvement effect on consumption efficiency resulting from the eco-driving mode. The saving consumption efficiency, the travelable distance, or the saved money amount can also be calculated as the actual improvement effect on consumption efficiency based on the energy source saving amount.

In the tenth aspect of the invention, the vehicle incudes the navigation device having road information from a departure place to a destination, the consumption efficiency information processing portion calculates the predicted improvement effect for each of the plurality types of efficiency improvement functions in the case of the ideal driving which fulfills the efficiency improvement function to the maximum based on the road information, and displays the predicted improvement effect on the display unit. This gives motivation for performing a driving operation with a sense of purpose in terms of the consumption efficiency, for example, for driving the vehicle such that the actual improvement effects approach the predicted improvement effects.

In the eleventh aspect of the invention, when the actual improvement effect is reset according to the predetermined reset condition, the actual improvement effects resulting from each of the plurality of types of the efficiency improvement functions are newly calculated based on the driving operation after the reset, and therefore, changes in the relative proportion etc. of the actual improvement effects can easily be recognized. Particularly, in the twelfth aspect of the invention, the actual improvement effects of the one or more times immediately before the reset are displayed on the display unit such that a comparison of the actual improvement effects of the one or more times immediately before the reset can be made with the current actual improvement effects, and therefore, changes in relative proportion etc. of the actual improvement effects resulting from the plurality of types of the efficiency improvement functions are easily understood, and a comparison of the actual improvement effects with an actual driving operation can be performed to easily actually feel a relationship between the improvement effects on consumption efficiency resulting from the plurality of types of the efficiency improvement functions and the driving operation.

### BRIEF DESCRIPTION OF DRAWINGS

FIG. 1 is a block diagram for explaining a general configuration of a vehicle including a vehicle display device to which the present invention is applied.

FIG. 2 is a flowchart for specifically explaining an operation when an actual improvement effect calculating portion functionally included in a vehicle control ECU of FIG. 1 calculates an actual improvement effect on consumption efficiency resulting from free-run running.

FIG. 3 is a flowchart for specifically explaining an operation when the actual improvement effect calculating portion functionally included in the vehicle control ECU of FIG. 1 calculates an actual improvement effect on consumption efficiency resulting from idling reduction control.

FIG. 4 is a flowchart for specifically explaining an operation when the actual improvement effect calculating portion functionally included in the vehicle control ECU of FIG. 1 calculates an actual improvement effect on consumption efficiency resulting from eco-driving.

FIG. 5 is a diagram for explaining a specific example of an improvement effect display portion of a display unit of FIG. 1.

FIG. 6 is a diagram for explaining another example of the improvement effect display portion of the display unit of FIG. 1.

FIG. 7 is a diagram for explaining still another example of the improvement effect display portion of the display unit of FIG. 1.

FIG. 8 is a diagram for explaining still another example of the improvement effect display portion of the display unit of FIG. 1.

FIG. 9 is a diagram for explaining still another example of the improvement effect display portion of the display unit of FIG. 1.

FIG. 10 is a diagram for explaining still another example of the improvement effect display portion of the display unit of FIG. 1.

FIG. 11 is a diagram for explaining still another example of the improvement effect display portion of the display unit of FIG. 1.

### MODES FOR CARRYING OUT THE INVENTION

An energy source of a vehicle is appropriately determined depending on a drive power source for running, and when the drive power source is an engine (internal combustion engine) such as a gasoline engine and a diesel engine generating power by combustion of fuel, the energy source is the fuel such as gasoline, light oil, and gas. When the drive power source is an electric motor such as a motor generator, the energy source is electric energy stored in an in-vehicle battery or fuel of a fuel cell (such as hydrogen) generating electricity. In the case of a hybrid vehicle including an engine and an electric motor as a drive power source, both the fuel and the electrical energy of the in-vehicle battery serve as the energy source. The consumption efficiency of the energy source is fuel consumption (fuel consumption rate; km/liter etc.) that is a running distance per unit volume, etc. in the case of the fuel, and is electric consumption (electric consumption rate; km/J etc.) that is a running distance per unit electric power amount etc. in the case of the electric energy. Based on the power generation efficiency resulting from the engine, the electric consumption can be converted into the fuel consumption for unification into the fuel consumption, or conversely, unification into electric consumption can also be performed. A vehicle display device according to the present invention does not necessarily need to display the consumption efficiency itself and may be able to display a specific numerical value or a relative proportion for each of multiple efficiency improvement functions in terms of an energy source saving amount, a saving consumption efficiency, a travelable distance derived from the energy source saving amount, a saved money amount derived from the energy source saving amount, and the like, related to the improvement effect on consumption efficiency.

A consumption efficiency improvement portion is configured to have at least two efficiency improvement functions. Specifically, for example, the portion is configured to include a free-run running control portion separating the engine serving as the drive power source from a power transmission path to stop rotation of the engine during coasting with an accelerator turned off an idling reduction control portion stopping the rotation of the engine serving as the drive power source during stop of the vehicle, and an eco-driving portion limiting an operation of an air conditioner when an eco-driving mode is selected. Additionally, in a vehicle having a mechanically or electrically controlled continuously variable transmission, if stepped shifting can be performed in a simulated manner in addition to stepless shifting, the stepless shifting relatively advantageous in consumption efficiency can also be regarded as an efficiency improvement function. When automatic shifting and manual shifting are possible, an automatic shifting function can also be regarded as an efficiency improvement function. In the case of a vehicle capable of automatic driving such as auto-cruise running that is automatic constant speed running at a constant vehicle speed, this automatic driving function can also be regarded as an efficiency improvement function in some cases. The free-run running control portion may retain the engine in an idling state without stopping the rotation. Even in this case, the fuel consumption efficiency is improved because of an increase in a coasting distance etc. due to separation of the engine from a power transmission path. In the eco-driving mode, the consumption efficiency can also be improved by changing a shift line in a shift map of an automatic transmission, changing characteristics of an accelerator operation amount and a drive power source output (throttle valve opening degree etc.), and reducing an idling rotation speed of an engine serving as the drive power source. In any case, an actual improvement effect of consumption efficiency (such as an energy source saving amount) can be calculated from a map or an arithmetic expression predefined according to the contents of the efficiency improvement function.

For example, an actual improvement effect calculating portion is desirably capable of resetting a calculation value of the actual improvement effect according to reset conditions such as a driver's ON/OFF operation of a driving switch such as an IG (ignition) switch enabling driving of the vehicle, a driver's reset operation of an odometer such as a trip meter, filling of the energy source, a predefined running distance, a predefined driving time, a predefined consumption amount of the energy source, a stop of the vehicle, a driver's reset operation to the actual improvement effect, etc. The driver may be allowed to select which reset condition is used for the reset. Although it is desirable to display on the display unit the actual improvement effect of one or more times immediately before the reset, only the current actual improvement effect may be displayed. A moving average of the actual improvement effect may be calculated and displayed according to a predefined running distance or driving time or a consumption amount of the energy source, or a change in the moving average may be displayed as a line graph etc. For example, an instantaneous value of about several seconds may successively be displayed on the display unit, and various other forms are available.

An improvement effect display control portion performs display on the display unit such that, for example, the actual improvement effects by multiple types of efficiency improvement functions can be compared by lengths of bars in a bar chart or may be displayed on a pie chart or as numerical values. A difference in the actual improvement effect can also be expressed by a difference in color or brightness, and various other forms are available. Although the actual improvement effect can be represented by, for example, the energy source saving amount, the saving consumption efficiency, the travelable distance, the saved money amount, etc., multiple items among them may be displayed or the driver may be allowed to select the display contents.

### EXAMPLE

An example of the present invention will now be described in detail with reference to the drawings.

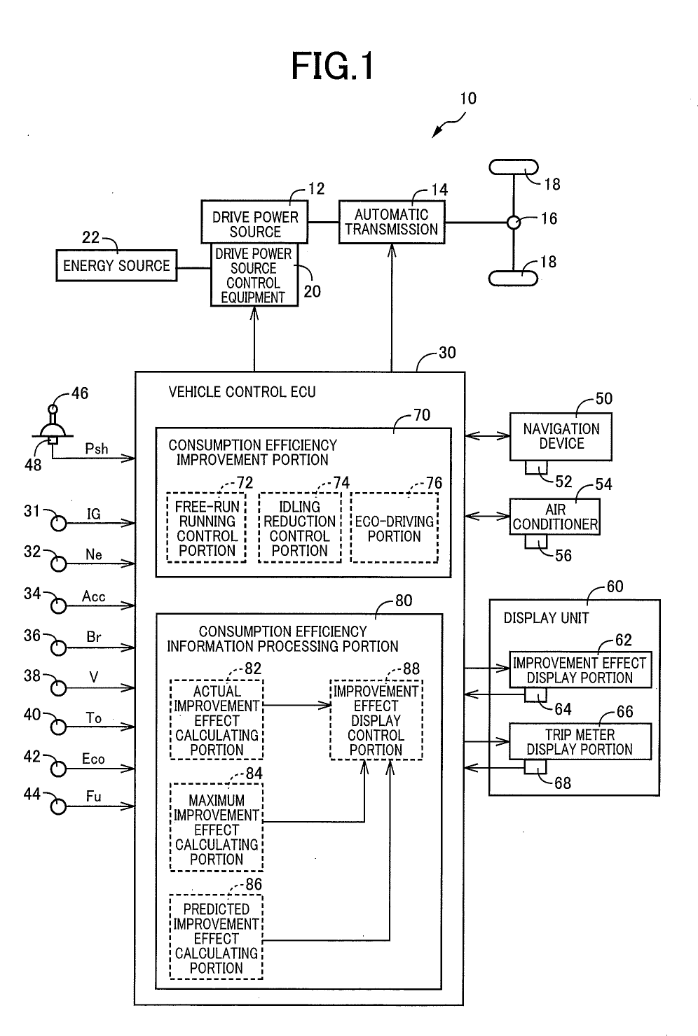

FIG. 1 is a block diagram for explaining a general configuration of a drive system and a control system of a vehicle 10 including a vehicle display device according to an example of the present invention. The vehicle 10 includes a drive power source 12, an automatic transmission 14, a final reduction gear unit 16, and left and right drive wheels 18. The drive power source 12 is an engine that is an internal combustion engine such as a gasoline engine or a diesel engine, for example, or an electric motor etc., and in the case where the drive power source 12 is the engine, a supply amount etc. of a fuel such as gasoline and light oil serving as an energy source 22 are controlled through drive power source control equipment 20 having a fuel supply device etc., so that an output (such as torque) is controlled according to a driver's output request amount such as an accelerator operation amount Acc. The drive power source control equipment 20 is configured to include an ignition device, an electronic throttle valve, etc. in addition to the fuel supply device. In the case where the drive power source 12 is the electric motor, an inverter etc. are included as the drive power source control equipment 20, and a supply electric power etc. from an electric storage device such as a battery serving as the energy source 22 or a fuel cell using hydrogen etc. as the energy source 22 are controlled, so that an output (such as torque) is controlled according to the driver's output request amount such as the accelerator operation amount Acc. In this example, description will mainly be made of the case that an engine is included as the drive power source 12. The automatic transmission 14 is a multi-speed transmission of a planetary gear type etc., a mechanically controlled continuously variable transmission of a belt type etc., an electrically controlled continuously variable transmission having a differential mechanism, a forward/backward running switching device, etc., and can establish in this example a drive state enabling forward running of the vehicle 10, a reverse state enabling backward running of the vehicle 10, and a neutral state in which power transmission is interrupted. A hydraulic power transmission such as a torque converter is disposed as needed between the drive power source 12 and the automatic transmission 14.

The vehicle 10 includes a vehicle control ECU (electronic control unit) 30 as a controller providing various controls including an output control of the drive power source 12 by the drive power source control equipment 20 and a shift control of the automatic transmission 14. The vehicle control ECU 30 is configured to include a microcomputer having a CPU, a ROM, a RAM, an I/O interface, etc., and executes a predetermined signal process according to a program stored in advance in the ROM while utilizing a temporary storage function of the RAM. The vehicle control ECU 30 is supplied with a signal indicative of a lever operation position Psh from a lever position sensor 48 detecting the operation position Psh of a shift lever 46 and is also supplied with various pieces of information necessary for the various controls, from a driving switch 31 such as an ignition (IG) switch, an engine rotation speed sensor 32, an accelerator operation amount sensor 34, a brake operation force sensor 36, a vehicle speed sensor 38, an outside air temperature sensor 40, an eco-driving mode selection switch 42, an energy source remaining amount meter 44, etc., such as an IG signal enabling driving of the vehicle 10, a rotation speed (engine rotation speed) Ne of the engine (the drive power source 12), the operation amount (accelerator operation amount) Acc of an accelerator pedal, an operation force (brake operation force) Br of a brake pedal, a vehicle speed V, an outside air temperature To, an eco-driving mode selection signal Eco, and an energy source remaining amount Fu.

The shift lever 46 is disposed near a driver's seat, for example, and can manually be operated to at least a D position, an R position, a P position, and an N position, can be operated and moved to the D position to select a D (drive) range for forward running in which the automatic transmission 14 is in a drive state, and can be operated and moved to the R position to select an R (reverse) range for backward running in which the automatic transmission 14 is in a reverse state. The shift lever 46 can be operated and moved to the N position to select an N (neutral) range in which the automatic transmission 14 is in a neutral state and can be operated and moved to the P position to select a P (parking) range for parking in which the automatic transmission 14 is in the neutral state with a parking lock gear meshed. The vehicle speed V can be detected from a rotation speed of an output shaft of the automatic transmission 14, a wheel speed of the drive wheels 18 and driven wheels, etc., and a running distance of the vehicle 10 can be calculated based on the vehicle speed V.

A navigation device 50, an air conditioner 54, and a display unit 60 are also connected to the vehicle control ECU 30. The navigation device 50 has map data including road information, can capture current position information, current road information, etc. by GPS (Global Positioning System) etc., and has functions of obtaining a running route from a departure place to a destination set by a setting device 52 and guiding for running along the running route. The air conditioner 54 is capable of adjusting temperature and humidity in the vehicle interior and has an automatic air-conditioning function of automatically adjusting the temperature in the vehicle interior to a target temperature T* set by a setting device 56. The display unit 60 is, for example, a VFD (Vacuum Fluorescent Display) panel or a liquid crystal display panel, is disposed on an instrument panel etc. near the driver's seat to display the vehicle speed V, the energy source remaining amount Fu, the lever operation position Psh, etc., and includes a trip meter display portion 66 displaying a running distance Ltr of the vehicle 10 measured by the trip meter. The running distance Ltr displayed on the trip meter display portion 66 can be reset by a reset switch 68.

The display unit 60 also has an improvement effect display portion 62 displaying information on an improvement effect on consumption efficiency (such as fuel consumption) of the energy source, i.e., an actual improvement effect on consumption efficiency resulting from multiple types of efficiency improvement functions. The improvement effect display portion 62 can switch the display contents, reset the improvement effect, or set the timing of the reset (reset condition) by a setting device 64. In addition to the reset operation by the setting device 64, the reset condition may be selected from, for example, the time of input of the IG signal according to a driver's ON operation of the driving switch 31, the time of a driver's reset operation of the running distance Ltr of the trip meter, the time of a filling operation of the fuel serving as the energy source 22, a predefined running distance, a predefined driving time, a predefined consumption amount of the energy source 22, i.e., a change amount of the energy source remaining amount Fu, the time of stop of the vehicle when the vehicle speed V becomes substantially zero, etc. The setting device 64 can also set a unit cost C of the fuel such as gasoline serving as the energy source 22. The unit cost C may be set through wireless communication at the time of refueling etc.

The vehicle control ECU 30 controls the output of the drive power source 12 via the drive power source control equipment 20 according to the accelerator operation amount Acc etc., causes the automatic transmission 14 to shift gears according to a predefined shift map (shift line), and also functionally includes a consumption efficiency improvement portion 70 and a consumption efficiency information processing portion 80. The consumption efficiency improvement portion 70 is a portion having the multiple types of efficiency improvement functions contributing to the improvement in the consumption efficiency of the energy source and, in this example, has three types of efficiency improvement functions from a free-run running control portion 72, an idling reduction control portion 74, and an eco-driving portion 76.

The free-run running control portion 72 puts the automatic transmission 14 into the neutral state during coasting with the accelerator turned off at the accelerator operation amount Acc of substantially zero and separates the engine serving as the drive power source 12 from the power transmission path to stop rotation of the engine, thereby suppressing the consumption of the energy source 22 through idling etc. of the engine. For example, when a depressing operation of the brake pedal is performed, the operation of the free-run running control portion 72 is canceled to return the automatic transmission 14 to the drive state so that the drive power source 12 is rotationally driven and that the engine brake can be applied.

The idling reduction control portion 74 stops the rotation of the engine serving as the drive power source 12 at the time of stop of the vehicle 10, thereby suppressing the consumption of the energy source 22 by idling etc. of the engine. The operation of the idling reduction control portion 74 is executed, for example, when the brake operation force Br of the brake pedal is equal to or greater than a predetermined determination value, and is canceled to restart the engine when the brake operation force Br falls below the determination value. The operation of the idling reduction control portion 74 may be executed, for example, when the shift lever 46 is retained at the D position, and the engine may be restarted when the shift lever 46 is operated and moved to the N position or the P position, so that the idling reduction control may be performed and canceled depending on the lever operation position Psh.

When the eco-driving mode selection switch 42 is operated to select an eco-driving mode, the eco-driving portion 76 performs the eco-driving mode for limiting the automatic air-conditioning function of the air conditioner 54 to reduce the engine load to suppress the consumption of the energy source 22. For example, a range of temperature adjustment by the air conditioner 54 is limited depending on the outside air temperature To etc. Alternatively, for example, the shift line of the automatic transmission 14 can be changed, or an idling rotation speed of the engine serving as the drive power source 12 can be reduced, to suppress the consumption of the energy source 22.

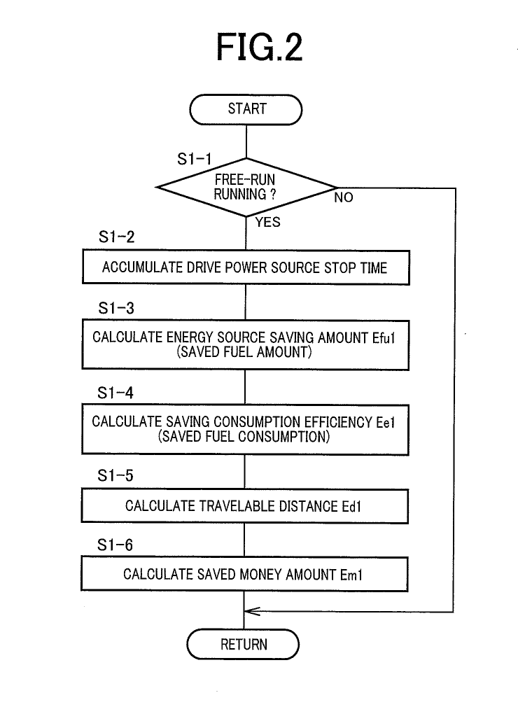

The consumption efficiency information processing portion 80 displays information on the consumption efficiency of the energy source 22 during driving of the vehicle 10 on the display unit 60 and functionally includes an actual improvement effect calculating portion 82, a maximum improvement effect calculating portion 84, a predicted improvement effect calculating portion 86, and an improvement effect display control portion 88. In this example, the vehicle display device is configured to include the consumption efficiency information processing portion 80 and the display unit 60. The actual improvement effect calculating portion 82 individually calculates the actual improvement effects on consumption efficiency resulting from the three types of efficiency improvement functions included in the consumption efficiency improvement portion 70 and, specifically, for example, as shown in flowcharts shown in FIGS. 2 to 4, the saving amount of the energy source 22, the saving consumption efficiency, the travelable distance, and the saved money amount are calculated as the actual improvement effects. Any one of these actual improvement effects is selected by the setting device 64 and displayed on the improvement effect display portion 62. Although the energy source saving amount, the saving consumption efficiency, the travelable distance, and the saved money amount are calculated as the actual improvement effects in this example, only one of them may be calculated and displayed on the improvement effect display portion 62. This actual improvement effect is an estimated value of the actual improvement effect on consumption efficiency and is reset according to the reset condition defined by the setting device 64 disposed in the improvement effect display portion 62.

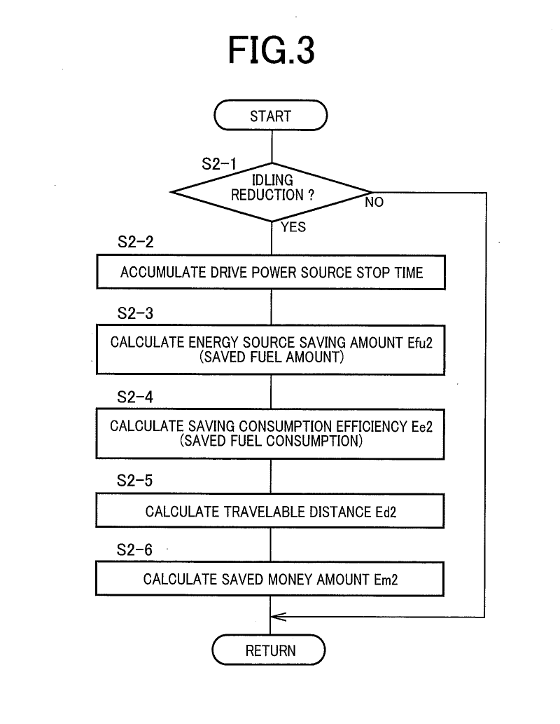

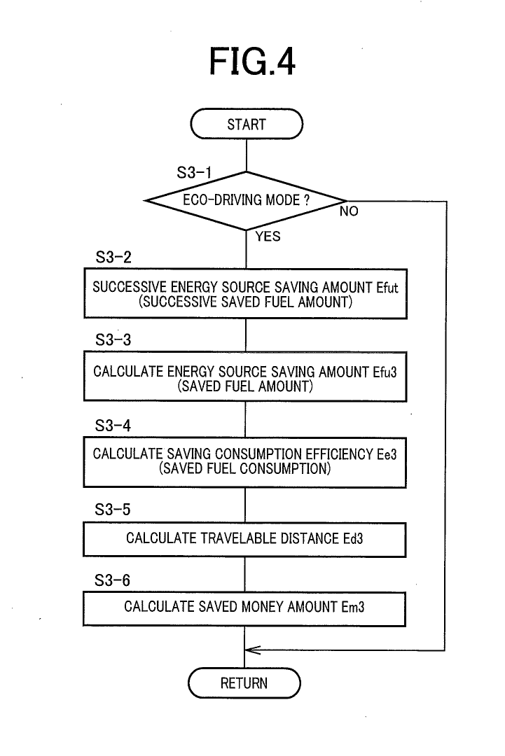

FIG. 2 is for calculating the improvement effect on the consumption efficiency of the energy source 22 resulting from the free-run running control portion 72, and a signal process is executed according to steps S1-1 to S1-6 (hereinafter simply referred to as S1-1 to S1-6; step will be omitted also in FIGS. 3 and 4). At S1-1, it is determined whether the free-run running is being performed by the free-run running control portion 72 and if the free-run running is not being performed, the process is simply terminated, or if the free-run running is being performed, S1-2 is executed. At S1-2, a time of stop of the engine (the drive power source 12) due to the free-run running is accumulated by a timer, a counter, etc. At S1-3, the engine stop time accumulated at S1-2 is multiplied by a preset fuel consumption amount during engine idling to calculate a saving amount Efu1 (liter) of the energy source 22, i.e., a saved fuel amount. At S1-4, a saving consumption efficiency Ee1 (km/liter), i.e., a saved fuel consumption, is calculated as a difference between an actual consumption efficiency Er and a virtual consumption efficiency Ei according to the following Eq. (1). The actual consumption efficiency Er is a value obtained by dividing a running distance Lv (km) of the vehicle 10 after reset of the improvement effect displayed on the improvement effect display portion 62 according to the predetermined reset condition by a consumption amount ΔFu (liter) of the energy source 22, and the virtual consumption efficiency Ei is a value obtained by dividing the running distance Lv by an amount obtained by adding the saving amount Efu1 to the consumption amount ΔFu of the energy source 22. The energy source consumption amount ΔFu can be calculated from a change in the energy source remaining amount Fu or can be obtained by successively accumulating the fuel supply amount from the drive power source control equipment 20. The running distance Lv can be obtained by integrating the vehicle speed V.

Ee=Er−Ei=(Lv/ΔFu)−[Lv/(ΔFu+Efu1)] (1)

At S1-5, a travelable distance Ed1 is calculated by multiplying the energy source saving amount Efu1 by the actual consumption efficiency Er. For the energy source consumption amount ΔFu when calculating the actual consumption efficiency Er in this case, the consumption amount only during running of the vehicle may be used. At S1-6, the energy source saving amount Efu1 is multiplied by the fuel unit cost C to calculate a saved money amount Em1. The energy source saving amount Efu1, the travelable distance Ed1, and the saved money amount Em1 are in a proportional relationship, and when a proportional relationship of the energy source saving amounts Efu1 for efficiency improvement functions is displayed as shown in FIG. 5, the travelable distance Ed1 and the saved money amount Em1 may not necessarily be calculated since the relationship is the same.

FIG. 3 is for calculating the improvement effect on the consumption efficiency of the energy source 22 resulting from the idling reduction control portion 74. At S2-1 of FIG. 3, it is determined whether the idling reduction control is being provided by the idling reduction control portion 74 and if the idling reduction control is not being provided, the process is simply terminated, or if the idling reduction control is being provided, i.e., if the automatic transmission 14 is put into the neutral state at the time of stop of the vehicle 10 and the engine (the drive power source 12) is stopped rotating, S2-2 is executed. At S2-2, the engine stop time due to the idling reduction control is accumulated by a timer, a counter, etc. At S2-3 to S2-6, an energy source saving amount Efu2, a saving consumption efficiency Ee2, a travelable distance Ed2, and a saved money amount Em2 are respectively calculated as in S1-3 to S1-6 of FIG. 2.

FIG. 4 is for calculating the improvement effect on the consumption efficiency of the energy source 22 resulting from the eco-driving portion 76. At S3-1 in FIG. 4, it is determined whether the eco-driving mode is being performed by the eco-driving portion 76 and, if the eco-driving mode is not being performed, the process is simply terminated, or if the eco-driving mode is being performed, i.e., if the automatic air-conditioning function of the air conditioner 54 is limited, S3-2 is executed. At S3-2, a difference in the consumption amount of the energy source 22 due to a difference between the operation state of the air conditioner 54 with limitation on the automatic air-conditioning function and the operation state of the air conditioner 54 without limitation on the automatic air-conditioning function is calculated as a successive energy source saving amount Efut. The successive energy source saving amount Efut is calculated from a map etc. predefined by using, for example, a temperature difference between a set target temperature T* and a temperature adjustment range limited by the eco-driving mode as a parameter. When the eco-driving mode changes the shift line of the automatic transmission 14 or reduces the idling rotation speed of the drive power source 12, the successive energy source saving amount Efut may be calculated and added from a rotation speed difference between the engine rotation speeds Ne in the eco-driving mode and in a normal operation mode, each depending on different gear speeds which are determined based on the vehicle speeds V and the accelerator operation amounts Acc, for example.

At S3-3, the successive energy source saving amount Efut is sequentially accumulated to calculate a cumulative energy source saving amount Efu3 after the reset. At S3-4 to S3-6, as in S1-4 to S1-6 in FIG. 2, a saving consumption efficiency Ee3, a travelable distance Ed3, and a saved money amount Em3 are each calculated based on the energy source saving amount Efu3.

Returning to FIG. 1, the maximum improvement effect calculating portion 84 functionally included in the consumption efficiency information processing portion 80 calculates a maximum improvement effect in the case of an ideal driving which achieves the maximum performance for improvement in consumption efficiency of the energy source 22 for each of the three types of the efficiency improvement functions. Specifically, since the free-nm running by the free-run running control portion 72 is canceled when a brake operation is performed, the energy source saving amount Efu1 in the case of a driving operation performed with a braking operation used as little as possible during coasting is calculated as in the flowchart of FIG. 2, and the energy source saving amount Efu1 is defined as a maximum energy source saving amount Efu1max. A maximum saving consumption efficiency Ee1max, a maximum travelable distance Ed1max, and a maximum saved money amount Em1max are calculated based on the maximum energy source saving amount Efu1max. Since the idling reduction by the idling reduction control portion 74 is canceled depending on the brake operation force Br being lower than the predetermined determination value or depending on the operation position Psh of the shift lever 46, the energy source saving amount Efu2 in the case of a driving operation performed so as not to cancel the idling reduction as much as possible during stop of the vehicle 10 is calculated as in the flowchart of FIG. 3, and the energy source saving amount Efu2 is defined as a maximum energy source saving amount Efu2max. A maximum saving consumption efficiency Ee2max, a maximum travelable distance Ed2max, and a maximum saved money amount Em2max are calculated based on the maximum energy source saving amount Efu2max. Since the eco-driving mode by the eco-driving portion 76 is performed when the eco-driving mode is selected by the eco-driving mode selection switch 42, the energy source saving amount Efu3 in the case of the eco-driving mode constantly selected is calculated as in the flowchart of FIG. 4, and the energy source saving amount Efu3 is defined as a maximum energy source saving amount Efu3max. A maximum saving consumption efficiency Ee3max, a maximum travelable distance Ed3max, and a maximum saved money amount Em3max are calculated based on the maximum energy source saving amount Efu3max.

When the navigation device 50 sets the running route from a departure place to a destination, the predicted improvement effect calculating portion 86 functionally included in the consumption efficiency information processing portion 80 calculates a predicted improvement effect in the case of the ideal driving which achieves the maximum performance for improvement in consumption efficiency of the energy source 22 for each of the three types of the efficiency improvement functions, based on road information including a speed limit, road height information, traffic congestion information, etc. of the running route. For example, specific driving conditions of the vehicle 10 such as running speed, acceleration/deceleration, and vehicle stop time are set based on the road information to calculate the predicted improvement effect in the case of the ideal driving performed under the conditions in the same way as the maximum improvement effect. An update can sequentially be made even during running based on new road information. As a result, a predicted energy source saving amount Efu1ide etc. are calculated as the predicted improvement effect on consumption efficiency resulting from the free-run running control portion 72; a predicted energy source saving amount Efu2ide etc. are calculated as the predicted improvement effect on consumption efficiency resulting from the idling reduction control portion 74; and a predicted energy source saving amount Efu3ide etc. are calculated as the predicted improvement effect on consumption efficiency resulting from the eco-driving portion 76.

The improvement effect display control portion 88 functionally included in the consumption efficiency information processing portion 80 displays on the improvement effect display portion 62 of the display unit 60 an actual improvement effect selected by the setting device 64 out of the actual improvement effects such as the energy source saving amounts Efu1, Efu2, Efu3 obtained respectively for the three types of efficiency improvement functions. i.e., the free-run running, the idling reduction, and the eco-driving mode, such that a comparison can mutually be made between the efficiency improvement functions. FIG. 5 shows an example of the displayed contents by the improvement effect display portion 62, which is the case that the saved fuel consumptions, i.e., the saving consumption efficiencies Ee1 to Ee3, are displayed as the actual improvement effects on consumption efficiency by using a difference in lengths of bars in a bar chart. FIG. 5 shows the case that the setting device 64 is set to display the maximum improvement effects resulting from the ideal driving, and the maximum saving consumption efficiencies (maximum saved fuel consumptions) Ee1max to Ee3max are displayed as the maximum improvement effects calculated by the maximum improvement effect calculating portion 84 in a second row such that a comparison can be made with the saving consumption efficiencies Ee1 to Ee3 which are displayed in the first row. In this case, the improvement effects resulting from the efficiency improvement functions are displayed as relative proportion when the sum of the maximum saving consumption efficiencies Ee1max to Ee3max is 100. If the energy source saving amount is selected by the setting device 64, the energy source saving amounts Efu1 to Efu3 and the maximum energy source saving amounts Efu1max to Efu3max are displayed, and if the travelable distance is selected, the travelable distances Ed1 to Ed3 and the maximum travelable distances Ed1max to Ed3max are displayed. If the saved money amount is selected, the saved money amounts Em1 to Em3 and the maximum saved money amounts Em1max to Em3max are displayed. The maximum improvement effects may not necessarily be displayed for the respective efficiency improvement functions, and only the total value (the lengths of bars in the bar chart) of the maximum improvement effects resulting from the three types of the efficiency improvement functions may be displayed.

As a result, among the three types of the efficiency improvement functions, i.e., the free-run running, the idling reduction, and the eco-driving mode, which function largely contributes to the improvement in fuel consumption can be identified at a glance. Additionally, a comparison of the saved fuel consumption with the maximum saved fuel consumption i.e., the ideal driving in the second row of FIG. 5 reveals which efficiency improvement function is not sufficiently functioning, or in other words, has a high margin for improvement in fuel consumption, and in the case of FIG. 5, the fuel consumption can further be improved by performing a driving operation so as not to cancel the idling reduction, for example, by comparatively strengthening the brake operation force Br in the vehicle stopped state so that the idling reduction function having a high margin is sufficiently fulfilled. If a proportion of the actual improvement effect (saved fuel consumption of FIG. 5) to the maximum improvement effect (maximum saved fuel consumption of FIG. 5) resulting from each of the efficiency improvement functions is low, for example, equal to or less than a predefined determination value (e.g., about ½), the improvement effect display control portion 88 increases brightness, or changes color, of the display portion of the efficiency improvement function for highlighting (hatched portion of FIG. 5), so that the efficiency improvement function having a high margin for improvement in the fuel consumption can easily be recognized. Although the proportion equal to or less than the determination value corresponds to a determination criterion, it may be determined that the proportion is low when the state of being equal to or lower than the determination value continues for a predetermined time period or longer or over a certain running distance or more, or other various forms are available. Conversely, when the proportion of the actual improvement effect to the maximum improvement effect is equal to or greater than the predetermined determination value, the display portion of the efficiency improvement function may be highlighted.

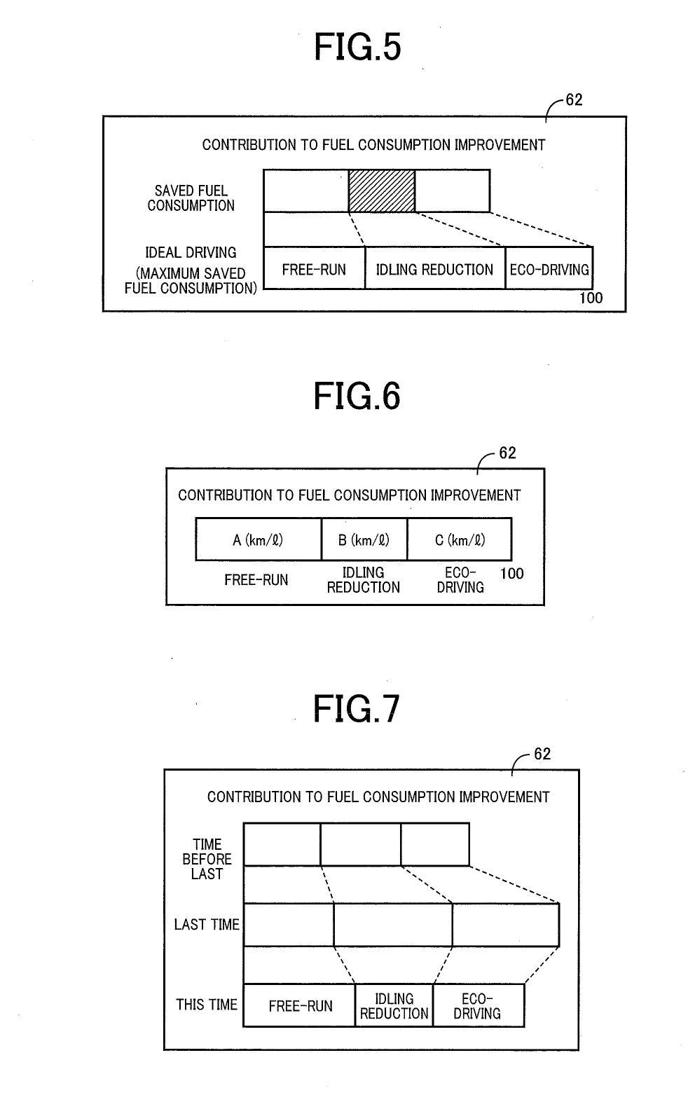

FIG. 6 shows another example of the display contents displayed on the improvement effect display portion 62 of the display unit 60 by the improvement effect display control portion 88. FIG. 6 shows the case that only the actual improvement effects (e.g., the saving consumption efficiencies Ee1 to Ee3) shown in the upper row of FIG. 5 are displayed, and lengths of bars in a bar chart are determined according to a relative proportion of each of the actual improvement effects when the overall length is 100. In the bar chart, specific numerical values A, B, C of the actual improvement effects resulting from the respective efficiency improvement functions are displayed. This case reveals not only the relative contribution to improvement in fuel consumption of the three types of the efficiency improvement functions but also specific saving consumption efficiencies Ee1 to Ee3, so that the improvement effects on the fuel consumption can more specifically be imaged. A total of the saving consumption efficiencies (Ee1+Ee2+Ee3) resulting from the three types of the efficiency improvement functions may also be displayed. Alternatively, only the bar chart may be displayed without the specific numerical values A, B, C, or conversely, only the specific numerical values A, B, C may be displayed without the bar chart. The same applies to the case of displaying the other actual improvement effects, i.e., the energy source saving amounts Efu1 to Efu3, the travelable distances Ed1 to Ed3, and the saved money amounts Em1 to Em3. These display contents can arbitrarily be set by the setting device 64.

FIG. 7 shows yet another example of the display contents displayed on the improvement effect display portion 62 of the display unit 60 by the improvement effect display control portion 88. FIG. 7 shows the case that if a reset of the actual improvement effects is performed according to the predetermined reset condition set by the setting device 64, the actual improvement effects (e.g., the saving consumption efficiencies Ee1 to Ee3) of the efficiency improvement functions of the two most recent times before the reset (the last time and the time before last) are displayed on a bar chart such that a comparison of the actual improvement effects before the reset (the last time and the time before last) can be made with the present (current) actual improvement effects (e.g., the saving consumption efficiencies Ee1 to Ee3). Specifically, if the actual improvement effects are reset according to the predetermined reset condition, the improvement effect display control portion 88 stores the actual improvement effects resulting from the efficiency improvement functions at the two most recent times and displays the effects on the bar chart together with the current actual improvement effects resulting from the efficiency improvement functions. In this case, since changes in the relative proportion of the actual improvement effects resulting from the efficiency improvement functions for each reset can easily be understood, a comparison of the actual improvement effects with an actual driving operation can be performed to easily actually feel a relationship between the improvement effects on consumption efficiency resulting from the three types of the efficiency improvement functions and the driving operation. Whether to display the most recent actual improvement effects before the reset in this way can arbitrarily be set by the setting device 64. The actual improvement effects before the reset may not necessarily be displayed for the respective efficiency improvement functions, and only the total value (the lengths of bars in the bar chart) of the actual improvement effects resulting from the three types of the efficiency improvement functions may be displayed.

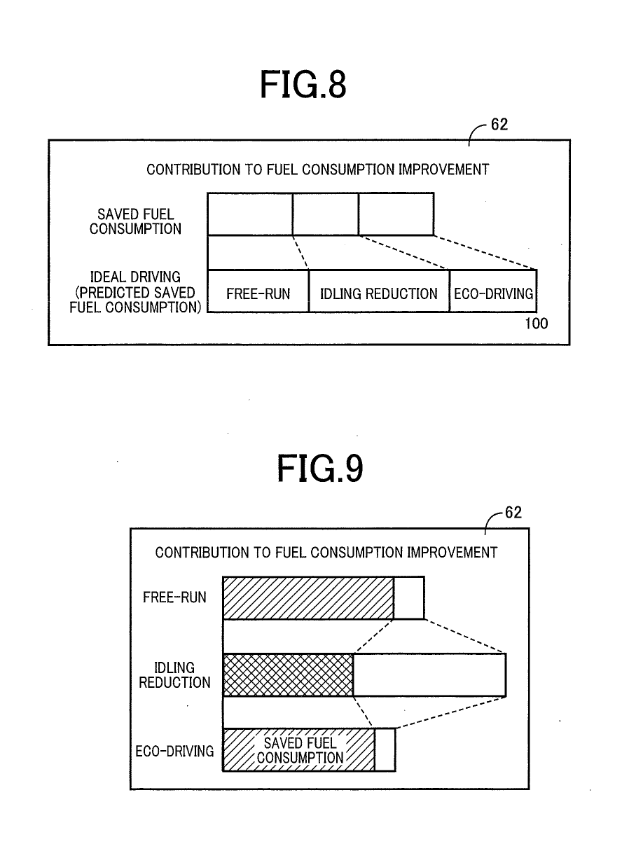

FIG. 8 is a further example of the display contents displayed on the improvement effect display portion 62 of the display unit 60 by the improvement effect display control portion 88. FIG. 8 shows the case that the setting device 64 is set to display the predicted improvement effects resulting from the ideal driving, and when the running route is set by the navigation device 50, the predicted improvement effects (e.g., predicted saving consumption efficiencies Ee1ide to Ee3ide) calculated by the predicted improvement effect calculating portion 86 are displayed in the second row such that a comparison of the predicted improvement effects can be made with the actual improvement effects (e.g., the saving consumption efficiencies Ee1 to Ee3). This case gives motivation for performing a driving operation with a sense of purpose in terms of the consumption efficiency, for example, for driving the vehicle such that the actual improvement effects approach the predicted improvement effects. The predicted improvement effects may not necessarily be displayed for the respective efficiency improvement functions, and only the total value (the length of bars in the bar chart) of the predicted improvement effects resulting from the three types of the efficiency improvement functions may be displayed.

As described above, the vehicle display device of the vehicle 10 of this example individually calculates the actual improvement effects on consumption efficiency (the energy source saving amounts Efu1 to Efu3, the saving consumption efficiencies Ee1 to Ee3, the travelable distances Ed1 to Ed3, the saved money amounts Em1 to Em3) resulting from the three types of the efficiency improvement functions, i.e., the free-run running, the idling reduction, and the eco-driving mode, and displays the effects on the display unit 60 such that a comparison can mutually be made between the efficiency improvement functions, and therefore, the driver can easily recognize which function contributes to what extent to improvement in consumption efficiency among the multiple types of the efficiency improvement functions. As a result, the driver can actually feel the improvement effects on consumption efficiency resulting from the efficiency improvement functions and is also motivated to reflect the contribution of the efficiency improvement functions to the consumption efficiency on the driving operation for further improvement in the consumption efficiency by, for example, driving the vehicle 10 such that the efficiency improvement function with low improvement effect is consciously fulfilled.

Since the vehicle display device calculates the maximum improvement effects (the maximum energy source saving amounts Efu1max to Efu3max, saving consumption efficiencies Ee1max to Ee3max, travelable distances Ed1max to Ed3max, saved money amounts Em1max to Em3max) in the case of the ideal driving which achieves the maximum performance for each of the three types of the efficiency improvement functions, and displays the actual improvement effects on the display unit 60 according to the display setting by the setting device 64 such that a comparison of the actual improvement effects can be made with the maximum improvement effects, a margin of the improvement effect (a difference of the actual improvement effect from the maximum improvement effect) on consumption efficiency resulting from each of the efficiency improvement functions can specifically be understood. As a result, the margin of the improvement effect of each of the efficiency improvement functions can be reflected on the driving operation for aiming further improvement in the consumption efficiency by, for example, driving the vehicle 10 such that the efficiency improvement function having a high margin is consciously fulfilled. Particularly, in this example, since the display portion of the efficiency improvement function having a low proportion of the actual improvement effect to the maximum improvement effect is highlighted, the efficiency improvement function can easily be recognized and reflected on the driving operation.

Since the actual improvement effect obtained for each of the three types of the efficiency improvement functions is displayed on the display unit 60 such that a comparison can be made therebetween based on the lengths of bars in the bar chart, a difference in relative contribution degree of each of the three types of the efficiency improvement functions can easily be recognized.

Since the consumption efficiency improvement portion 70 includes the free-nm running control portion 72 and the energy source saving amount Efu1 is calculated as the actual improvement effect on consumption efficiency based on the rotation stop time of the engine (the drive power source 12) attributable to the free-run running control portion 72 and the fuel consumption amount during idling of the engine, the energy source saving amount Efu1 can highly accurately be obtained as the actual improvement effect on consumption efficiency resulting from the free-run running. The saving consumption efficiency Ee1, the travelable distance Ed1, or the saved money amount Em1 can also highly accurately be calculated as the actual improvement effect on consumption efficiency based on the energy source saving amount Efu1.

Since the consumption efficiency improvement portion 70 includes the idling reduction control portion 74 and the energy source saving amount Efu2 is calculated as the actual improvement effect on consumption efficiency based on the rotation stop time of the engine (the drive power source 12) attributable to the idling reduction control portion 74 and the fuel consumption amount during idling, the energy source saving amount Efu2 can highly accurately be obtained as the actual improvement effect on consumption efficiency resulting from the idling reduction. The saving consumption efficiency Ee2, the travelable distance Ed2, or the saved money amount Em2 can also highly accurately be calculated as the actual improvement effect on consumption efficiency based on the energy source saving amount Efu2.

Since the consumption efficiency improvement portion 70 includes the eco-driving portion 76, and a difference in the consumption amount of the energy source 22 due to a difference between the operation state of the air conditioner 54 with operation limited by the eco-driving portion 76 and the operation state of the air conditioner 54 without operation limitation is calculated as the successive energy source saving amount Efut so that the successive energy source saving amount Efut is sequentially accumulated to calculate the cumulative energy source saving amount Efu3, the energy source saving amount Efu3 can highly accurately be obtained as the actual improvement effect on consumption efficiency resulting from the eco-driving mode. The saving consumption efficiency Ee3, the travelable distance Ed3, or the saved money amount Em3 can also highly accurately be calculated as the actual improvement effect on consumption efficiency based on the energy source saving amount Efu3.

Since a selection by the setting device 64 from the energy source saving amounts Efu1 to Efu3, the saving consumption efficiencies Ee1 to Ee3, the travelable distances Ed1 to Ed3, and the saved money amounts Em1 to Em3 is displayed on the display unit 60, the driver can easily specifically image the improvement effects on consumption efficiency resulting from the three types of the efficiency improvement functions. Particularly, in the case of FIG. 6, since the specific numerical values A, B, C are displayed, the improvement effects on consumption efficiency resulting from the efficiency improvement functions can more specifically be imaged.

When the actual improvement effect is reset according to the reset condition including the reset operation by the setting device 64, the actual improvement effects resulting from the efficiency improvement functions are newly calculated based on the driving operation after the reset, and therefore, changes in the relative proportion etc. of the actual improvement effects can easily be recognized. Particularly, when the actual improvement effects of the two most recent times before the reset are displayed according to the display setting by the setting device 64 such that a comparison of the actual improvement effects of the two most recent times before the reset can be made with the current actual improvement effects as shown in FIG. 7, changes in relative proportion etc. of the actual improvement effects resulting from the three types of the efficiency improvement functions are easily understood, and a comparison of the actual improvement effects with an actual driving operation can be performed to easily actually feel a relationship between the improvement effects on consumption efficiency resulting from the three types of the efficiency improvement functions and the driving operation.

When the running route is set by the navigation device 50, the predicted improvement effects (e.g., the predicted saving consumption efficiencies Ee1ide to Ee3ide) in the case of the ideal driving which achieves the maximum performance for each of the three types of the efficiency improvement functions are displayed in the second row while the actual improvement effects (e.g., the saving consumption efficiencies Ee1 to Ee3) are displayed in the first row as shown in FIG. 8 such that a comparison therebetween can be made, according to the setting with the setting device 64. This gives motivation for performing a driving operation with a sense of purpose in terms of the consumption efficiency, for example, for driving the vehicle 10 such that the actual improvement effects approach the predicted improvement effects.

Other examples of the present invention will be described. In the following examples, portions substantially common to the example are denoted by the same reference numerals and will not be described in detail.

FIG. 9 shows another example of the display contents displayed on the improvement effect display portion 62 of the display unit 60 by the improvement effect display control portion 88. FIG. 9 shows the case that the proportion (hatched or meshed portion) of the actual improvement effects (e.g., the saving consumption efficiencies Ee1 to Ee3) to the maximum improvement effects (e.g., the maximum saving consumption efficiencies Ee1max to Ee3max) resulting from the ideal driving is displayed on a bar chart for each of the three types of the efficiency improvement functions, and the lengths of bars in the bar chart of each of the efficiency improvement functions is determined based on the largest maximum improvement effect resulting from the ideal driving among the three types of the efficiency improvement functions, i.e., the maximum improvement effect resulting from idling reduction in FIG. 9. When the proportion of the actual improvement effect to the maximum improvement effect resulting from each of the efficiency improvement functions is low, for example, equal to or less than a predefined determination value (e.g., about ½), the display portion of the efficiency improvement function with the low proportion is highlighted (meshed portion), so that the same effect as FIG. 5 is obtained.

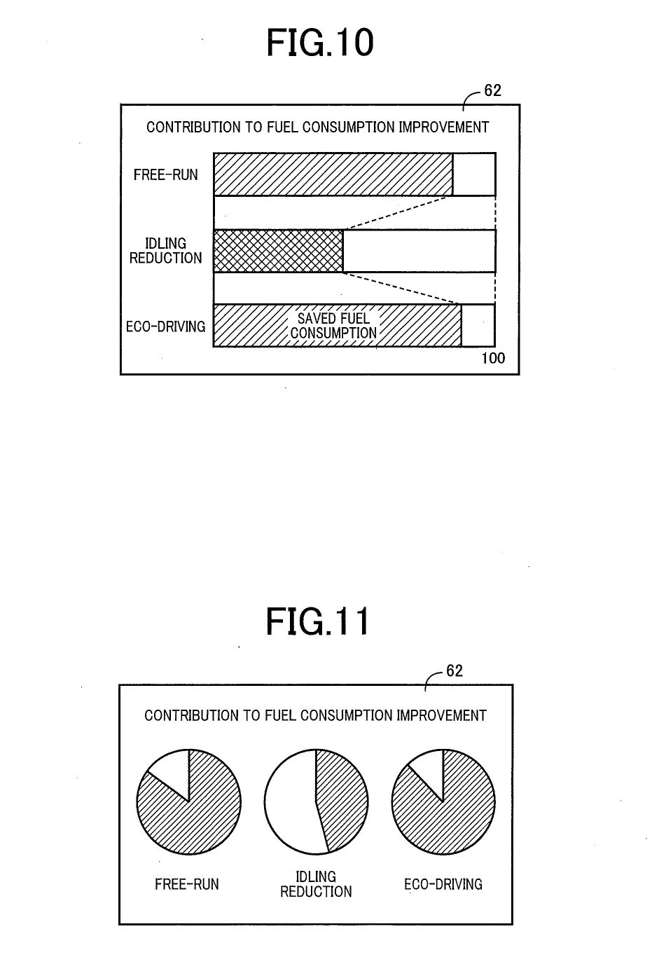

FIG. 10 shows yet another example of the display contents displayed on the improvement effect display portion 62 of the display unit 60 by the improvement effect display control portion 88. Comparing to FIG. 9, FIG. 10 shows the case that the maximum improvement effects (e.g., the maximum saving consumption efficiencies Ee1max to Ee3max) resulting from the three types of the efficiency improvement functions are represented by the same length, which can further facilitate comprehension of the proportion (hatched or meshed portion) of the actual improvement effects (e.g., the saving consumption efficiencies Ee1 to Ee3) to the maximum improvement effects, i.e., a difference in margin of the efficiency improvement functions for the improvement in fuel consumption.

FIG. 11 is yet another example of the display contents displayed on the improvement effect display portion 62 of the display unit 60 by the improvement effect display control portion 88. Comparing to FIG. 10, FIG. 11 shows the case that the proportion (hatched portion) of the actual improvement effects (e.g., the saving consumption efficiencies Ee1 to Ee3) to the maximum improvement effects is displayed on a pie chart when the maximum improvement effect (e.g., the maximum saving consumption efficiencies Ee1max to Ee3max) resulting from the ideal driving is assumed as one rotation (360°) for each of the three types of the efficiency improvement functions. Although highlighting is not shown in FIG. 11, a display portion of the efficiency improvement function having a high proportion or a display portion of the efficiency improvement function having a low proportion may be highlighted as needed.

Although the examples of the present invention have been described in detail with reference to the drawings, these are merely an embodiment, and the present invention can be implemented in variously modified and improved forms based on the knowledge of those skilled in the art.

### REFERENCE SIGNS LIST

10: Vehicle 12: Drive power source 22: Energy source 50: Navigation device 54: Air conditioner 60: Display unit 70: Consumption efficiency improvement portion 72: Free-run running control portion 74: Idling reduction control portion 76: Eco-driving portion 80: Consumption efficiency information processing portion 82: Actual improvement effect calculating portion 84: Maximum improvement effect calculating portion 86: Predicted improvement effect calculating portion 88: Improvement effect display control portion Efu1 to Efu3: Energy source saving amount (Actual improvement effect) Efut: Successive energy source saving amount Ee1 to Ee3: Saving consumption efficiency (Actual improvement effect) Ed1 to Ed3: Travelable distance (Actual improvement effect) Em1 to Em3: Saved money amount (Actual improvement effect)

What is claimed is:

1. A vehicle display device including a consumption efficiency information processing portion configured to display information on consumption efficiency of an energy source during driving of a vehicle on a display unit, wherein
the vehicle includes a consumption efficiency improvement portion configured to include a plurality of types of efficiency improvement functions contributing to an improvement in the consumption efficiency, wherein
the consumption efficiency information processing portion includes
an actual improvement effect calculating portion individually configured to calculate an actual improvement effect on the consumption efficiency resulting from each of the plurality of types of efficiency improvement functions, and
an improvement effect display control portion configured to display the actual improvement effect obtained for each of the plurality of types of efficiency improvement functions on the display in a manner where each of the actual improvement effects are mutually compared.

2. The vehicle display device according to claim 1, wherein
the consumption efficiency information processing portion has a maximum improvement effect calculating portion configured to calculate a maximum improvement effect in the case of an ideal driving which fulfills each of the plurality of types of efficiency improvement functions to the maximum in terms of improvement in the consumption efficiency respectively, and wherein
the improvement effect display control portion displays the actual improvement effect on the display device in a manner where each of the actual improvement effects is compared with the corresponding maximum improvement effect.

3. The vehicle display device according to claim 2, wherein
when it is determined that a proportion of the actual improvement effect to the corresponding maximum improvement effect is high or low according to a predefined determination criterion for each of the efficiency improvement functions, the improvement effect display control portion performs highlighting such that the type of the efficiency improvement function related to the determined actual improvement effect is identified.

4. The vehicle display device according to claim 1, wherein
the improvement effect display control portion displays on the display device the actual improvement effect obtained for each of the plurality of types of efficiency improvement functions such that the actual improvement effects are evaluated using lengths in a bar chart.

5. The vehicle display device according to claim 1, wherein the actual improvement effect is at least one of a saving amount of the energy source being saved due to the efficiency improvement functions, a saving consumption efficiency that is a difference between a virtual consumption efficiency obtained by dividing a running distance by an amount obtained by adding the saving amount to a consumption amount of the energy source and an actual consumption efficiency, a travelable distance calculated by multiplying the saving amount by the actual consumption efficiency, and a money amount corresponding to the saving amount.

6. The vehicle display device according to claim 5, wherein the improvement effect display control portion displays a numerical value of the actual improvement effect on the display unit.

7. The vehicle display device according to claim 1, wherein
the consumption efficiency improvement portion includes as one of the efficiency improvement functions a free-run running control portion configured to separate an engine serving as a drive power source from a power transmission path to stop rotation during coasting with an accelerator turned off, and wherein
the actual improvement effect calculating portion calculates an energy source saving amount based on a rotation stop time of the engine due to the free-run running control portion and a fuel consumption amount during idling of the engine.

8. The vehicle display device according to claim 1, wherein
the consumption efficiency improvement portion includes as one of the efficiency improvement functions an idling reduction control portion configured to stop the rotation of the engine serving as the drive power source during stop of the vehicle, and wherein
the actual improvement effect calculating portion calculates an energy source saving amount based on a rotation stop time of the engine due to the idling reduction control portion and a fuel consumption amount during idling of the engine.

9. The vehicle display device according to claim 1, wherein
the consumption efficiency improvement portion includes as one of the efficiency improvement functions an eco-driving portion configured to limit an operation of an air conditioner when an eco-driving mode is selected, and wherein
the actual improvement effect calculating portion calculates a difference in consumption amount of the energy source due to a difference between an operation state of the air conditioner with operation limited by the eco-driving portion and an operation state of the air conditioner without operation limitation as a successive energy source saving amount so that the successive energy source saving amount is sequentially accumulated to calculate an energy source saving amount.

10. The vehicle display device according to claim 1, wherein
the vehicle includes a navigation device having road information from a departure place to a destination, wherein
the consumption efficiency information processing portion includes a predicted improvement effect calculating portion configured to calculate a predicted improvement effect for each of the plurality types of efficiency improvement functions in the case of the ideal driving which fulfills the efficiency improvement function to the maximum in terms of improvement in the consumption efficiency based on the road information from the departure place to the destination, and wherein
the improvement effect display control portion displays the predicted improvement effect on the display unit.

11. The vehicle display device according to claim 1, wherein
the actual improvement effect calculating portion resets the actual improvement effect in accordance with any predetermined reset condition out of a driver's operation of a driving switch for enabling driving of the vehicle, a driver's reset operation of an odometer, filling of the energy source, a predefined running distance, a predefined driving time, a predefined consumption amount of the energy source, a stop of the vehicle, and a driver's reset operation to the actual improvement effect and newly calculates the actual improvement effect based on a driving operation after the reset.

12. The vehicle display device according to claim 11, wherein
the improvement effect display control portion stores the actual improvement effect of one or more times immediately before the reset and displays the actual improvement effect in a manner where the stored actual improvement effect is compared with a current actual improvement effect.

13. The vehicle display device according to claim 1, wherein
the energy source is at least one of a fuel of an engine, a fuel of a fuel cell, an electric energy stored in an in-vehicle battery.
